(19) United States
(12) Patent Application Publication
(10) Pub. No.: US 2009/0025273 A1
(43) Pub. Date: Jan. 29, 2009

(54) Fish hook removal apparatus

(76) Inventor: Terry D. Gauger, Griffin, GA (US)

Correspondence Address: Terry D. Gauger, 50 Roy Norris Drive, Griffin, GA, 30223, US

(21) Appl. No.: 12/217,051

(22) Filed: Jul. 1, 2008

Related U.S. Application Data
(60) Provisional application No. 60/937,940, filed on Jul. 2, 2007.

(51) Int. Cl. A01K 97/18; A01K 97/00

(52) U.S. Cl. 43/53.5

(57) ABSTRACT

A fish hook removal apparatus is provided for removing a fish hook from a fish. The fish hook includes a barb, a bend, a shank, and a hook eye. The subject apparatus includes a handle portion and hook engagement and twisting means which are connected to the handle portion. The subject fish hook removal apparatus can be used to easily remove a fish hook from a fish. Preferably, the hook engagement and twisting means include a spiral spring portion which is connected to the handle portion, and a hook engagement end is connected to the spiral spring portion. Preferably, the hook engagement end includes a pair of finger members that are connected to the spiral spring portion. In accordance with another embodiment of the invention, a needle assembly is connected to the handle portion.

### CROSS-REFERENCE TO RELATED APPLICATION

This application claims priority based upon my copending Provisional Application Ser. No. 60/937,940; filed Jul. 2, 2007.

### BACKGROUND OF THE INVENTION

1. Field of the Invention

The present invention relates generally to devices for removing a fish hook from a hooked fish and, more particularly, to a fish hook remover especially adapted to be held in one hand of a user.

2. Description of the Prior Art

Fish hook removers are well known in the art. Throughout the years, a number of innovations have been developed relating to fish hook removers, and the following U.S. patents are representative of some of those innovations: U.S. Pat. Nos. 3,706,154, 4,028,825, 5,307,586, and 6,840,002.

More specifically, U.S. Pat. No. 3,706,154 discloses a fish hook remover that employs a J-shaped, hook-like engager for a fish hook. With use of the J-shaped, hook-like engager for a fish hook, the user engages the fish hook by hooking the fish hook with the J-shaped, hook-like engager. Then the user pulls back on the J-shaped, hook-like engager. However, if the user inadvertently only slightly pushes forward on the J-shaped, hook-like engager, then the J-shaped, hook-like engager can disengage from the fish hook. Then, the user must repeat the process to reengage the fish hook with the J-shaped, hook-like engager. In this respect, it would be desirable if a fish hook remover were provided which does not cause a disengagement of the fish hook remover from a fish hook when a user inadvertently only slightly pushes forward on a J-shaped, hook-like engager that is engaged with the fish hook.

U.S. Pat. No. 4,028,825 discloses a fish hook remover than employs a corkscrew-like fish hook engager. Because the fish hook engager is corkscrew-like, when the corkscrew-like fish hook engager is rotated to engage the fish hook, the corkscrew-like engager may screw into the mouth of the hooked fish. Then, it will be necessary to unscrew the corkscrew-like element from the mouth of the hooked fish. To avoid such a problem, it would be desirable if a fish hook remover were provided with fish hook engager that is not corkscrew-shaped.

U.S. Pat. No. 5,307,586 discloses a fish hook remover that employs a piston-like plunger inside a cylindrical tube and employs a compression spring that biases the motion of the plunger with respect to the cylindrical tube. Often, to avoid a piston from seizing inside a cylinder, adequate lubrication must be provided between the piston and the cylinder. In the watery environment of the activity of fishing, it would be desirable if a fish hook remover were provided that does not employ a piston moving inside a cylinder.

U.S. Pat. No. 6,840,002 discloses a fish hook remover that has a spiral looped hooked removal end. Once the spiral looped hooked removal end engages the fish hook, a sleeve is slid over the region of the fish-hook-engaging spiral looped hooked removal end. For the spiral looped hooked removal end to properly engage the fish hook, quite a bit of precision is required by the user. In a moving environment, such as a bouncing boat, it may be difficult for a user to precisely engage the spiral looped hooked removal end with a fish hook. In this respect, it would be desirable if a fish hook remover were provided which does not include a spiral looped hooked removal end.

Sometimes the hook eye of a fish hook becomes closed due to paint or cement therein. When this happens, threading a fishing line through the hook eye is not possible. In this respect, it would be desirable if a fish hook remover were provided with a sharp tool that can be used to break open the closure of a hook eye.

Thus, while the foregoing body of prior art indicates it to be well known to use fish hook removers, the prior art described above does not teach or suggest a fish hook removal apparatus which has the following combination of desirable features: (1) does not cause a disengagement of the fish hook remover from a fish hook when a user inadvertently only slightly pushes forward on a J-shaped, hook-like engager that is engaged with the fish hook; (2) provides a fish hook engager that is not corkscrew-shaped; (3) does not employ a piston moving inside a cylinder; (4) does not include a spiral looped hooked removal end; and (5) provides a sharp tool that can be used to break open the closure of a hook eye. The foregoing desired characteristics are provided by the unique fish hook removal apparatus of the present invention as will be made apparent from the following description thereof. Other advantages of the present invention over the prior art also will be rendered evident.

### SUMMARY OF THE INVENTION

To achieve the foregoing and other advantages, the present invention, briefly described, provides a fish hook removal apparatus for removing a fish hook from a fish. The fish hook includes a barb, a bend, a shank, and a hook eye. The subject apparatus includes a handle portion and hook engagement and twisting means which are connected to the handle portion. The subject fish hook removal apparatus can be used to easily remove a fish hook from a fish.

Preferably, the hook engagement and twisting means include a spiral spring portion which is connected to the handle portion, and a hook engagement end is connected to the spiral spring portion.

Preferably, the hook engagement end includes a pair of finger members that are connected to the spiral spring portion. More specifically, each of the pair of finger members includes an outwardly extending finger end, and an outwardly extending rounded portion connected between the outwardly extending finger end and the spiral spring portion.

Preferably, the spiral spring portion and the pair of finger members are formed as an integrated spring/fingers combination.

Preferably, the integrated spring/fingers combination includes a pair of metal wires twisted around each other to form the spiral spring portion, and free ends of the respective wires are formed into the pair of finger members. The handle portion can include an open channel.

In accordance with another embodiment of the invention, a needle assembly is connected to the handle portion. More specifically, the handle portion includes a needle-reception portion which includes an internally threaded portion. In addition, the needle assembly includes a needle portion which is received in the needle-reception portion. An externally threaded portion is provided which engages the internally threaded portion of the needle-reception portion, and a needle assembly handle portion is connected to the externally threaded portion and the needle portion. A suspension ring can be connected to the needle assembly handle portion.

The above brief description sets forth rather broadly the more important features of the present invention in order that the detailed description thereof that follows may be better understood, and in order that the present contributions to the art may be better appreciated. There are, of course, additional features of the invention that will be described hereinafter and which will be for the subject matter of the claims appended hereto.

In this respect, before explaining at least two preferred embodiments of the invention in detail, it is understood that the invention is not limited in its application to the details of the construction and to the arrangements of the components set forth in the following description or illustrated in the drawings. The invention is capable of other embodiments and of being practiced and carried out in various ways. Also, it is to be understood, that the phraseology and terminology employed herein are for the purpose of description and should not be regarded as limiting.

As such, those skilled in the art will appreciate that the conception, upon which disclosure is based, may readily be utilized as a basis for designing other structures, methods, and systems for carrying out the several purposes of the present invention. It is important, therefore, that the claims be regarded as including such equivalent constructions insofar as they do not depart from the spirit and scope of the present invention.

It is therefore an object of the present invention to provide a new and improved fish hook removal apparatus which has all of the advantages of the prior art and none of the disadvantages.

It is another object of the present invention to provide a new and improved fish hook removal apparatus which may be easily and efficiently manufactured and marketed.

It is a further object of the present invention to provide a new and improved fish hook removal apparatus which is of durable and reliable construction.

An even further object of the present invention is to provide a new and improved fish hook removal apparatus which is susceptible of a low cost of manufacture with regard to both materials and labor, and which accordingly is then susceptible of low prices of sale to the consuming public, thereby making such fish hook removal apparatus available to the buying public.

Still yet a further object of the present invention is to provide a new and improved fish hook removal apparatus which does not cause a disengagement of the fish hook remover from a fish hook when a user inadvertently only slightly pushes forward on a J-shaped, hook-like engager that is engaged with the fish hook.

Still another object of the present invention is to provide a new and improved fish hook removal apparatus that has a fish hook engager that is not corkscrew-shaped.

Yet another object of the present invention is to provide a new and improved fish hook removal apparatus which does not employ a piston moving inside a cylinder.

Even another object of the present invention is to provide a new and improved fish hook removal apparatus that does not include a spiral looped hooked removal end.

Still a further object of the present invention is to provide a new and improved fish hook removal apparatus which has a sharp tool that can be used to break open the closure of a hook eye.

These together with still other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

The invention will be better understood and the above objects as well as objects other than those set forth above will become more apparent after a study of the following detailed description thereof. Such description makes reference to the annexed drawing wherein:

FIG. 1 is a front view showing a first embodiment of the fish hook removal apparatus of the invention.

FIG. 2 is a side view of the embodiment of the fish hook removal apparatus shown in FIG. 1 taken along line 2-2 of FIG. 1.

FIG. 3 is an enlarged cross-sectional view of a portion of the embodiment of the fish hook removal apparatus of FIG. 2 taken along line 3-3 thereof.

FIG. 4 is a front view showing a second embodiment of the fish hook removal apparatus of the invention, which includes a needle assembly received in the handle of the apparatus.

FIG. 5 is an exploded view of the needle assembly that is removed from the handle of the apparatus.

FIG. 6 is a side view showing the fish hook removal apparatus of the invention in use for removing a fish hook from a fish.

FIG. 7 is a front view showing a third alternatively preferred embodiment of the fish hook removal apparatus of the invention.

FIG. 8 is a side view of the alternatively preferred third embodiment of FIG. 7.

### DESCRIPTION OF THE PREFERRED EMBODIMENT

With reference to the drawings, a new and improved fish hook removal apparatus embodying the principles and concepts of the present invention will be described.

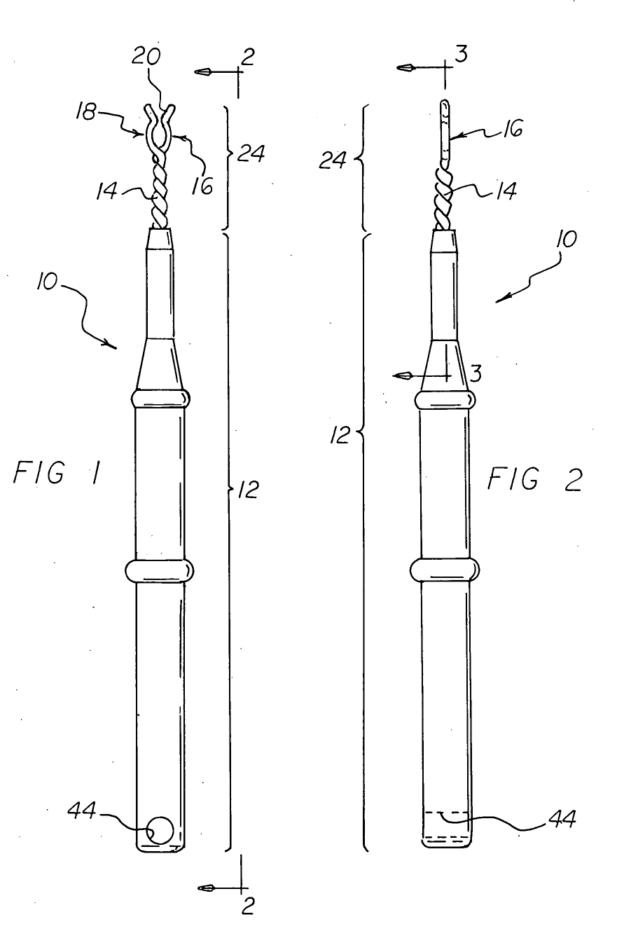

Turning to FIGS. 1-3, there is shown a first embodiment of the fish hook removal apparatus of the invention generally designated by reference numeral 10. In each of the figures, reference numerals are shown that correspond to like reference numerals that designate like elements shown in other figures.

In the first embodiment, a fish hook removal apparatus 10 is provided for removing a fish hook 11 from a fish 13. The fish hook 11 includes a barb 15, a bend 17, a shank 19, and a hook eye 21. The subject apparatus includes a handle portion 12 and hook engagement and twisting means which are connected to the handle portion 12.

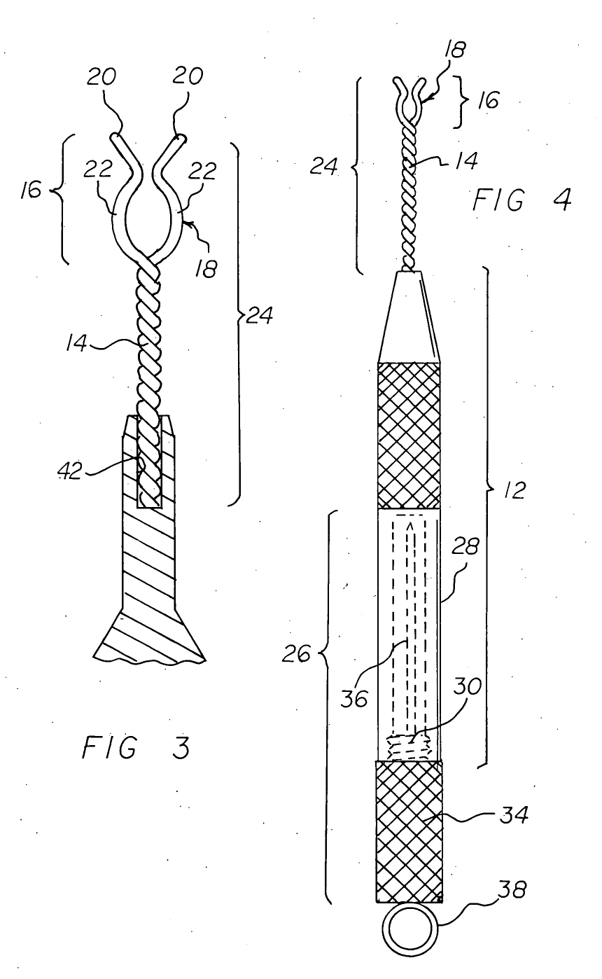

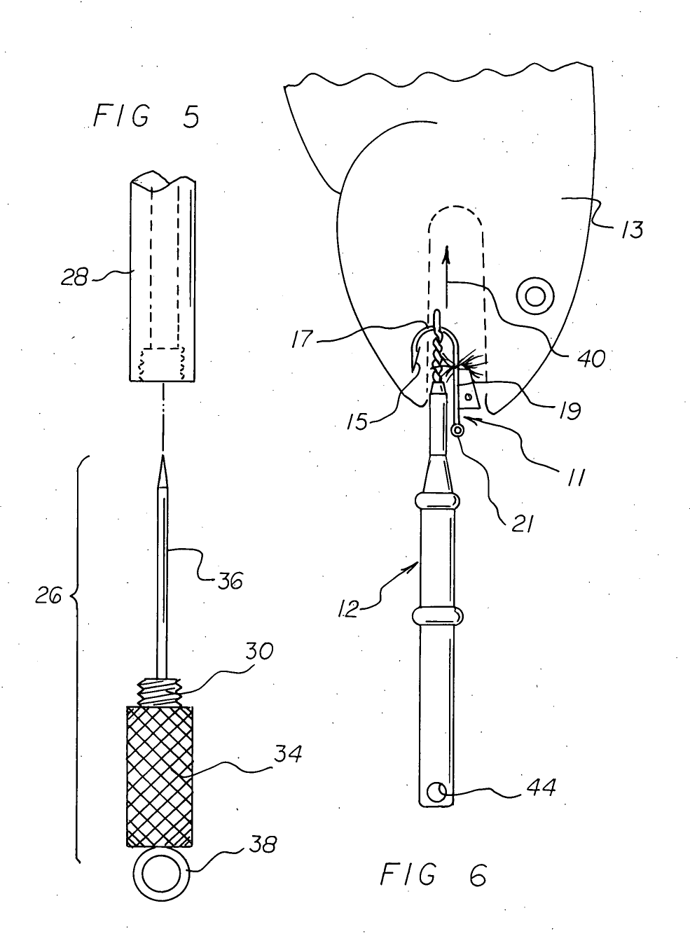

Preferably, the hook engagement and twisting means include a spiral spring portion 14 which is connected to the handle portion 12, and a hook engagement end 16 is connected to the spiral spring portion 14. As shown in FIG. 3, the spiral spring portion 14 can be received in a spring-reception well 42 in the handle portion 12.

Preferably, the hook engagement end 16 includes a pair of finger members 18 that are connected to the spiral spring portion 14. More specifically, each of the pair of finger members 18 includes an outwardly extending finger end 20, and an outwardly extending rounded portion 22 connected between the outwardly extending finger end 20 and the spiral spring portion 14.

Preferably, the spiral spring portion 14 and the pair of finger members 18 are formed as an integrated spring/fingers combination 24.

Preferably, the integrated spring/fingers combination 24 includes a pair of metal wires twisted around each other to form the spiral spring portion 14, and free ends of the respective wires are formed into the pair of finger members 18. The integrated spring/fingers combination 24 can be made of 0.045 inch stainless steel spring wire. The handle portion 12 can include an open channel 44.

To use the first embodiment of the invention, with reference to FIGS. 1-3 and 6, a user grasps the handle portion 12 with one hand. With the other hand, the user grasps a fish 13 in which the fish hook 11 has been set. The user moves the integrated spring/fingers combination 24 toward the bend 17 between the shank 19 and the barb 15. The fish hook removal apparatus 10 is installed on the fish hook 11 without interfering with a fishing line (not shown) which is attached to the hook eye 21. The outwardly extending finger ends 20 are placed to straddle the bend 17, and the user pushes the integrated spring/fingers combination 24 in the direction of the directional arrow 40 so that the barb 15 of the fish hook 11 enters between the outwardly extending rounded portions 22 of the hook engagement end 16. In this way, the barb 15 of the fish hook 11 is grasped by the hook engagement end 16 of the apparatus. Then, the user continues to push in the direction of the directional arrow 40 so that the spiral spring portion 14 can undergo a twisting action and so that the barb 15 of the fish hook 11 is pulled out from the fish 13 and is retained in the hook engagement end 16.

Then, the freed up fish hook 11 is carried out from the mouth of the fish 13 between the pair of finger members 18 of the integrated spring/fingers combination 24 when the apparatus is pulled in the direction opposite to the directional arrow 40. After the integrated spring/fingers combination 24, which carries the fish hook 11 therein, is removed from the fish 13, the fish hook 11 is pulled out from the integrated spring/fingers combination 24, and the fish hook removal apparatus 10 of the invention is ready for use again.

The open channel 44 can be used to attach a ring (not shown) or a tether (not shown) so that the fish hook removal apparatus 10 of the invention can be suspended from a belt or other item worn by the user.

In accordance with a third embodiment of the invention shown in FIGS. 7 and 8, the handle portion 12 features a first tapered portion 46 in which the spiral spring portion 14 can be received in the spring-reception well 42 (not shown in FIGS. 7 and 8). Integral with first tapered portion 46 is a second tapered portion 48 which, in turn is attached to a knurled band portion 50. The knurled band portion 50 is attached substantially as shown to the bottom portion 52 of handle portion 12 whereas axially spaced circular grooves 54, 56 separate the knurled band portion 50 from second tapered portion 46 and bottom handle portion 52. In accordance with the invention, the knurled band portion is located proximal to the second tapered portion 48 sufficiently to allow a user grasping the handle 12 by the hand to naturally and easily place the user's thumb and forefinger on that hand on the knurled portion. This arrangement makes it extremely easy to grip the fish hook removal apparatus 10 when it is being used as described above. In the third preferred embodiment a semi-circular ring 58 integral with the bottom end of the handle portion 12 may be used in lieu of channel 44 as will occur to those of ordinary skill. The suspension ring 38 can be used in a manner similar to the use of the open channel 44 in the handle portion 12 described above. Finally, the bottom handle portion 52 may provide a convenient surface for displaying a logo or other identifying indicia substantially as depicted FIG. 7.

The components of the fish hook removal apparatus of the invention can be made from inexpensive and durable metal and plastic materials.

As to the manner of usage and operation of the instant invention, the same is apparent from the above disclosure, and accordingly, no further discussion relative to the manner of usage and operation need be provided.

It is apparent from the above that the present invention accomplishes all of the objects set forth by providing a new and improved fish hook removal apparatus that is low in cost, relatively simple in design and operation, and which may advantageously be used without causing disengagement of the fish hook remover from a fish hook when a user inadvertently only slightly pushes forward on a J-shaped, hook-like engager that is engaged with the fish hook. With the invention, a fish hook removal apparatus has a fish hook engager that is not corkscrew-shaped. With the invention, a fish hook removal apparatus does not employ a piston moving inside a cylinder. With the invention, a fish hook removal apparatus is provided which does not include a spiral looped hooked removal end. With the invention, a fish hook removal apparatus provides a sharp tool that can be used to break open the closure of a hook eye.

Thus, while the present invention has been shown in the drawings and fully described above with particularity and detail in connection with what is presently deemed to be the most practical and preferred embodiment(s) of the invention, it will be apparent to those of ordinary skill in the art that many modifications thereof may be made without departing from the principles and concepts set forth herein, including, but not limited to, variations in size, materials, shape, form, function and manner of operation, assembly and use.

Hence, the proper scope of the present invention should be determined only by the broadest interpretation of the appended claims so as to encompass all such modifications as well as all relationships equivalent to those illustrated in the drawings and described in the specification.

Finally, it will be appreciated that the purpose of the annexed Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. Accordingly, the Abstract is neither intended to define the invention or the application, which only is measured by the claims, nor is it intended to be limiting as to the scope of the invention in any way.

1. A fish hook removal apparatus for removing a fish hook from a fish, wherein the fish hook includes a barb, a bend, a shank, and a hook eye, said apparatus, comprising:
a handle portion, and
hook engagement and twisting means connected to said handle portion.
wherein said hook engagement and twisting means include a spiral spring portion connected to said handle portion and a hook engagement end connected to said spiral spring portion, and
wherein said hook engagement end includes a pair of finger members connected to said spiral spring portion, and wherein each of said pair of finger members includes an outwardly extending finger end and an outwardly extending rounded portion connected between said outwardly extending finger end and said spiral spring portion.

2. The apparatus of claim 1 wherein said spiral spring portion and said pair of finger members are formed as an integrated spring/fingers combination.

3. The apparatus of claim 2 wherein said integrated spring/fingers combination includes a pair of metal wires twisted around each other to form said spiral spring portion, and wherein free ends of said respective wires are formed into said pair of finger members.

4. The apparatus of claim 1 wherein said handle portion includes an open channel.

5. The apparatus of claim 1, further including:
a needle assembly connected to said handle portion.

6. The apparatus of claim 5 wherein:
said handle portion includes a needle-reception portion which includes an internally threaded portion, and
said needle assembly includes a needle portion which is received in said needle-reception portion, an externally threaded portion which engages said internally threaded portion, and a needle assembly handle portion connected to said externally threaded portion and said needle portion.

7. The apparatus of claim 6, further including:
a suspension ring connected to said needle assembly handle portion.

8. The apparatus of claim 1 wherein said handle portion includes a knurled band portion axially positioned thereon.

9. The apparatus of claim 8 wherein said handle portion includes a first handle end portion proximal to said spiral spring portion and a second handle end portion remotely and oppositely spaced form said first handle end portion, and wherein said knurled band portion axially separates said first handle end portion from said second handle end portion.

10. The apparatus of claim 9 wherein said handle portion includes a pair of circumferential axially spaced grooves separating said knurled portion from said first handle end portion and said second handle end portion, respectively.
